(19) United States
(12) Patent Application Publication
(10) Pub. No.: US 2003/0079361 A1
(43) Pub. Date: May 1, 2003

(54) Wallpaper tool

(76) Inventor: Lynn A. Ernst, Rockford, IL (US)

Correspondence Address: LEYDIG VOIT & MAYER, LTD, 6815 WEAVER ROAD, ROCKFORD, IL, 61114-8018, US

(21) Appl. No.: 10/016,606

(22) Filed: Oct. 30, 2001

(51) Int. Cl. G01D 21/00

(52) U.S. Cl. 33/626

(57) ABSTRACT

A wallpapering tool is provided generally comprising a main portion and a leg portion. The main portion generally includes a handle and a blade defining a longitudinal axis. The blade is connected at one end to the handle, while the other free end of the blade defines a straight guiding edge. The leg portion is integrally formed with the main portion and projects laterally therefrom to further define the straight guiding edge. In one embodiment, the leg portion is defined solely by the blade. In another embodiment, the handle and blade in combination define the leg portion. The leg portion provides access to the straight guiding edge that would normally be blocked by the blade, the handle, a person's hand holding the took, or any combination thereof.

### FIELD OF THE INVENTION

The present invention relates generally to wallpaper tools, and more particularly relates to wallpapering tools that are used in cutting and shaping the wallpaper, such as putty knives.

### BACKGROUND OF THE INVENTION

Wallpaper is a very common interior design in many homes and office buildings. Wallpaper comes in several standard size rolls, typically having a decorative layer on one side, and a layer of adhesive on the other opposing side. Generally, the wallpaper is unrolled and cut into a strip of wallpaper which is then applied to a selected area of a building wall. The adhesive side of the wallpaper is wetted and then placed against the wall in a desired position. Any air bubbles or pockets are removed, and a final cut to the wallpaper is made to size the wallpaper for edges, corners, etc., which are formed by the walls, floors, ceilings, windows, cupboards, trim, vents and the like. A putty knife has a straight edge which is typically used as a guide for a razor to make the final cut in the wallpaper.

Unfortunately, the structure of many buildings or homes and the fixtures therein make wallpapering rather difficult, especially the final cut. For example, when there are thin strips of wall to be wallpapered, especially when there are two fixtures or objects projecting from the wall on opposite sides of that strip, it can be difficult to cut the wallpaper in that thin area. Such spaces can occur between the overhang of a cupboard and the floor or floorboard, between pieces of trim and other fixtures such as cabinets, doors or windows, and the area between a window sill and a fixture mounting curtains. Such situations are also further complicated when found in a corner. One difficulty often encountered is when an object protruding from the wall limits the angle at which the putty knife may be placed with its edge along the cut line, while that object and/or another object protruding from the wall confines access to the same area for cutting. More specifically, situations occur where the positioning of the putty knife in a person's hand holding the putty knife is restricted such that the person's hand and/or the putty knife are blocking access to the edge of the putty knife from a razor blade held in the person's other hand. In fact, there are many situations where it is practically impossible for a person to use the putty knife as a guide for cutting, and the final cut must be made by hand. Such cuts are not only time consuming, but are also more prone to uneven or otherwise poor cutting. In such situations, the wall may be left exposed, or the wallpaper may overlap onto a fixture such as a piece of trim.

### BRIEF SUMMARY OF THE INVENTION

In light of the above, it is a general aim of the present invention to provide a wallpapering tool that assists the cutting of wallpaper in the spaces which are difficult to access.

In that regard, it is also an object of the present invention to provide a wallpapering tool that provides a straight guiding edge that may be easily accessed by a cutting knife.

In accordance with these objects, the present invention provides a wallpapering tool comprising a main portion and a leg portion. The main portion generally includes a handle and a blade defining a longitudinal axis. The blade is connected at one end to the handle, while the other free end of the blade defines a straight guiding edge. The leg portion is integrally formed with the main portion and projects laterally therefrom to further define the straight guiding edge. Preferably, the leg portion has a substantially constant longitudinal length Lₗ across its width, Lₗ being substantially smaller than a longitudinal length Lₘ of the main portion. In one embodiment, the leg portion is defined solely by the blade. In another embodiment, the handle and blade in combination define the leg portion. The reduced length of the leg portion provides access to the straight guiding edge that would normally be blocked by the blade, the handle, a person's hand holding the took, or any combination thereof.

Also in accordance of these objects, the present invention provides a unique tool for guiding a knife cutting wallpaper. The tool comprises a handle and a blade connected to the handle, the blade projecting to a free end having a guiding edge. The blade and handle define a common longitudinal axis. A removed section provides access to the guiding edge. The removed section begins at a free end of the handle and extends to a straight edge formed in one of the blade and handle. In one embodiment, the straight edge is defined by the blade. In another embodiment, the straight edge is defined by the handle. Preferably, the straight edge is disposed generally parallel to the guiding edge and is spaced therefrom a short distance relative to the overall length of the wallpapering tool. It is also preferable to size the removed section to accommodate a substantial portion of a hand of a person gripping the knife handle. Similarly, the removed section is sized to permit the knife axis to be disposed on an angle substantially similar to the angle of the tool's longitudinal axis.

Other objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a perspective view of an embodiment of the wallpapering tool constructed in accordance with the teachings of the present invention;

FIG. 2 is a plan view of the wallpapering tool of FIG. 1;

FIG. 3 is a plan view of another embodiment of the wallpapering tool constructed in accordance with the teachings of the present invention;

FIG. 4 is a side view of an alternate embodiment of the wall papering tool constructed in accordance with the teachings of the present invention;

FIG. 5 is a side view of an alternate embodiment of the wall papering tool constructed in accordance with the teachings of the present invention;

FIG. 6 is a perspective view of a physical space where the wallpapering tools of FIGS. 1, 3, 4 and 5 may be employed;

FIG. 7 is a side view taken about line 7-7 of FIG. 6, while FIGS. 7a and 7b are similar views using the tools of FIGS. 4 and 5 respectively;

FIG. 8 is a perspective view of a physical space where the wallpapering tools of FIGS. 1 and 2 may be employed;

FIG. 9 is an enlarged view of the area denoted by circle 9 in FIG. 8;

FIG. 10 is an enlarged view of the area denoted by circle 10 in FIG. 8;

FIG. 11 is a side view taken about line 11-11 of FIG. 9;

FIG. 12 is a side view taken about line 12-12 of FIG. 10.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

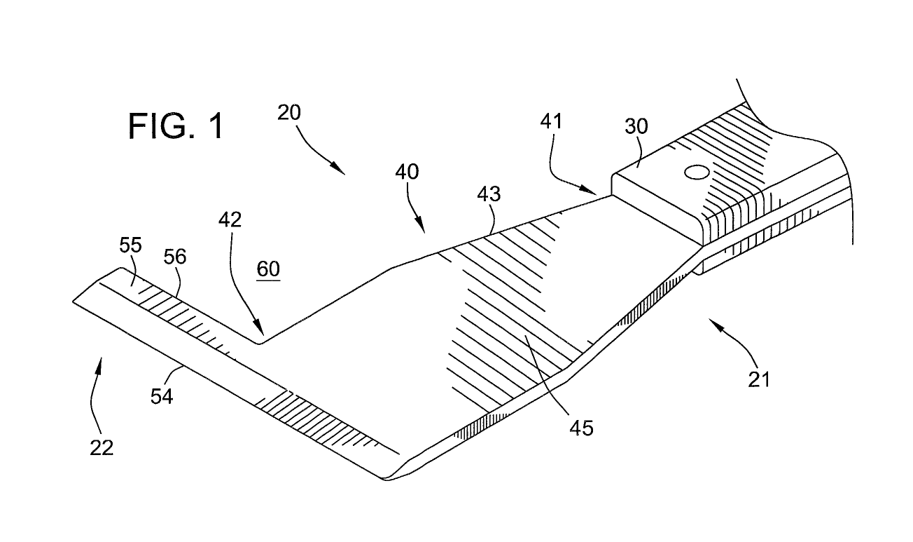

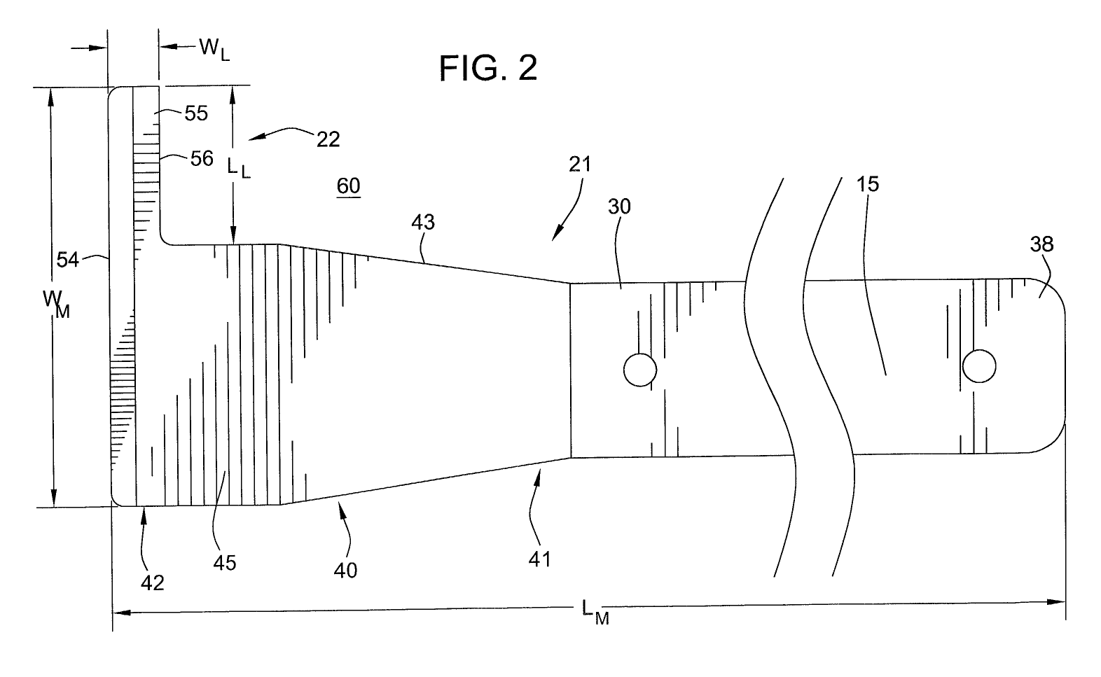

Referring now to the drawings, FIGS. 1 and 2 show an embodiment of the wallpaper tool 20 constructed in accordance with the teachings of the present invention. The wallpapering tool 20 generally comprises a main portion 21 and a leg portion 22. The main portion 21 of the tool 20 generally comprises a handle 30 and a blade 40 defining a common longitudinal axis 15. The blade 40 generally includes a first end 41 connected to the handle and a second free end 42 opposite the first end 41. In the embodiment illustrated in FIGS. 1 and 2, the leg portion 22 is integrally provided with the blade 40. Thus, the blade 40 generally comprises a body 45 and a leg 55. The leg 55 projects laterally from the body 45 of the blade 40, the free end of the body 45 and leg 55 of the blade 40 defining a straight guiding edge 54. The wallpapering tool 20 and its guiding edge 45 are used to, among other things, guide a blade while cutting wallpaper.

To describe the wallpapering tool 20 in a slightly different way, the tool includes a removed section 60 providing access to the guiding edge 54. The removed section 60 begins at a free end 38 of the handle 30 and extends to a straight edge 56 formed in the blade 40, and more particularly the leg 55 of the blade 40. The straight edge 56 is disposed generally parallel to the guiding edge 54. A lateral side 43 of the blade 40 also defines the removed section 60.

In order to provide increased access to the straight guiding edge 45, the length Lₗ of the leg portion 22, which in the current embodiment comprises the leg 55 of the blade 40, is sized substantially smaller than a longitudinal length Lₘ of the main portion 21 of the tool 20. The distance the leg portion 22 projects laterally, hereinafter referred to as the width Wₗ of the leg section, can vary substantially, although in the preferred embodiment Wₗ equals about 1.5 inches. The width Wₘ of the main portion 21, or more appropriately the width of the straight guiding edge 54, is approximately 3.5 inches in the preferred embodiment. The length Lₗ of the leg portion 22 in one embodiment is about ¼ inch while the length Lₘ of the main portion 21 is approximately 4.5 inches.

It can therefore be seen that the straight edge 56 defining the removed section 60 is spaced a short distance from the straight guiding edge 54 relative to the overall length Lₘ of the wallpapering tool. A lateral side 43 of the blade 40 is preferably angled relative to the longitudinal axis 15 and in conjunction with the straight edge 56, defines the removed section 60. The removed section 60 is preferably sized to accommodate a substantial portion of a hand of a person gripping a cutting knife. This area also accommodates the troublesome structures protruding from the wall. This area would normally be blocked by the blade, the handle, a person's hand holding the tool, or any combination thereof.

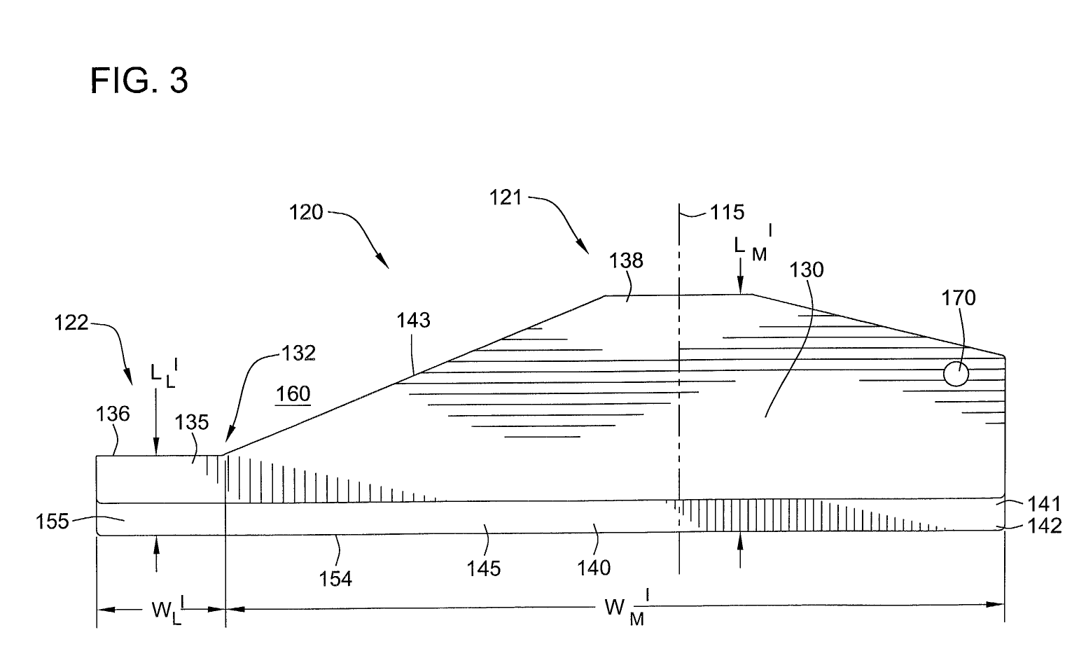

Turning to another embodiment of the wallpaper tool 120 constructed in accordance with the teachings of the present invention, FIG. 3 illustrates a wallpaper tool 120 having a main portion 121 and a leg portion 122. The tool 120 is generally comprised of a handle 130 and a blade 140. Preferably, the handle includes a small hole 170 for mounting or carrying the tool 120. The handle 130 and blade 140 define a longitudinal axis 115.

In the illustrated embodiment, the blade 140 is relative short, and includes a first end 141 attached to the handle 130 and a second free end 142. The second free end 142 of the blade 140 defines a straight guiding edge 154.

Unlike the embodiment of the invention depicted in FIGS. 1 and 2, wherein the leg portion 22 was defined entirely by the blade 40, the leg portion 122 of the present embodiment is defined by a leg section 135 of the handle 130 and the leg section 155 of the blade 140.

The leg portion 122 has a length Lₗ′ substantially smaller than a longitudinal length Lₘ′ of the main portion 121. In the currently illustrated embodiment, Lₗ′ equals about ½ inch, while Lₘ′ equals about 3 inches. The distance the leg portion 122 projects laterally, i.e. a width Wₗ′ of the leg portion 122, is approximately 1.5 inches. The width Wₘ′ of the main portion 121 is approximately 9.25 inches in the illustrated embodiment. As will be recognized, the leg portion 122 may project a greater distance laterally to provide increased access to a larger portion of the guiding edge 154.

As with the previous embodiment, the wallpapering tool 120 of the present invention can be described as having a removed section 160. The removed section 160 provides access to the guiding edge 154. The removed section begins at free end 138 of the handle and extends to a straight edge 136 formed in the handle 130. It will be noted that the straight edge 136 which partially defines a removed section 160 is defined by the handle 130 in the current embodiment, as opposed to the blade 40 in the previous embodiment. The handle 130 also includes a lateral side 143 which is angled relative to the longitudinal axis 115, and in conjunction with the straight edge 136 defines a removed section 160.

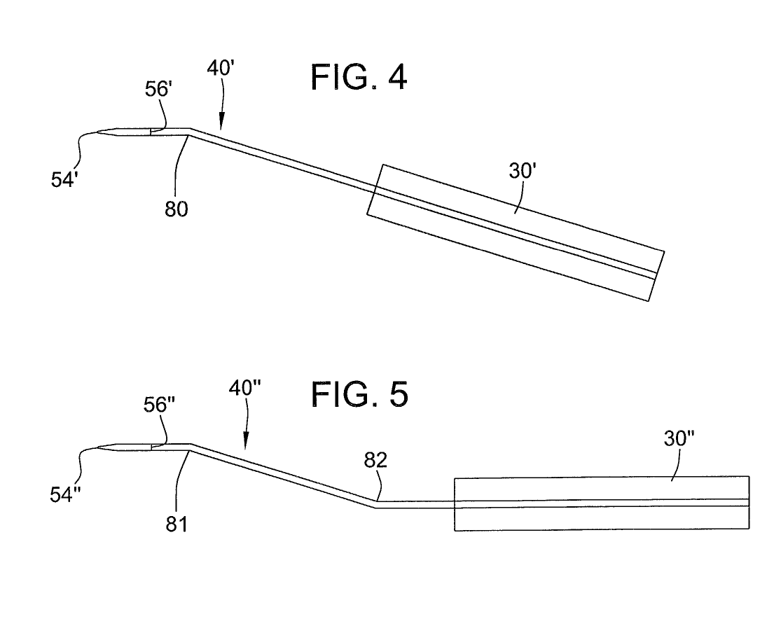

FIGS. 4 and 5 depict two alternate embodiments of the wallpapering tool 20′, 20″ similar to the embodiment of FIG. 1. Like numbers have been used for common components of the various embodiments, as will be readily recognized. As will be described in more detail below, the combined spaces with which we are dealing often require that the wallpapering tool 20 be flexed or deflected a small amount for proper utilization of the invention. In lieu of that flexure, these alternate embodiments are provided to accomplish the same. More specifically, the wallpapering tool 20′ of FIG. 4 includes a blade 40′ which has a bend 80 therein. The bend 80 extends parallel to the guiding edge 54 and is adjacent the straight edge 56′ formed in the blade 40′. Similarly the wallpapering tool 20″ of FIG. 5 includes a double bend indicated by reference numerals 81 and 82. The double end allows the handle 30″ to be kept generally parallel with the wall during its use.

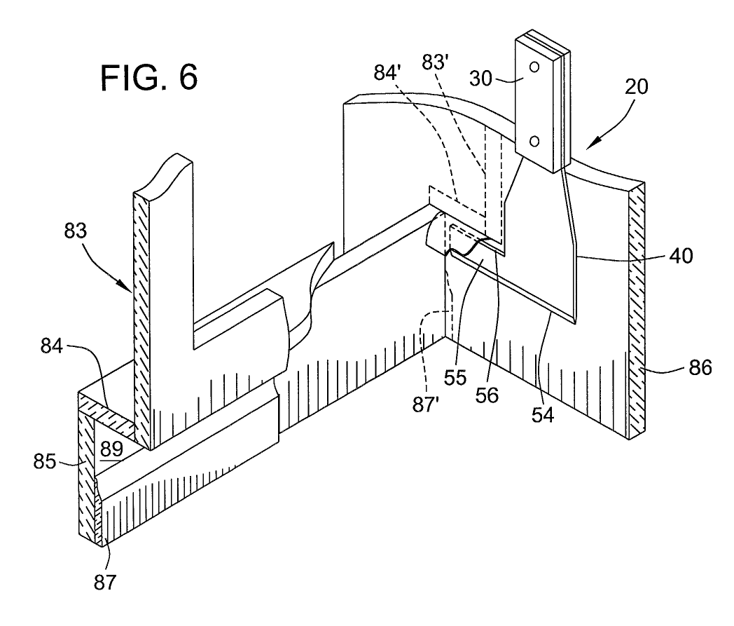

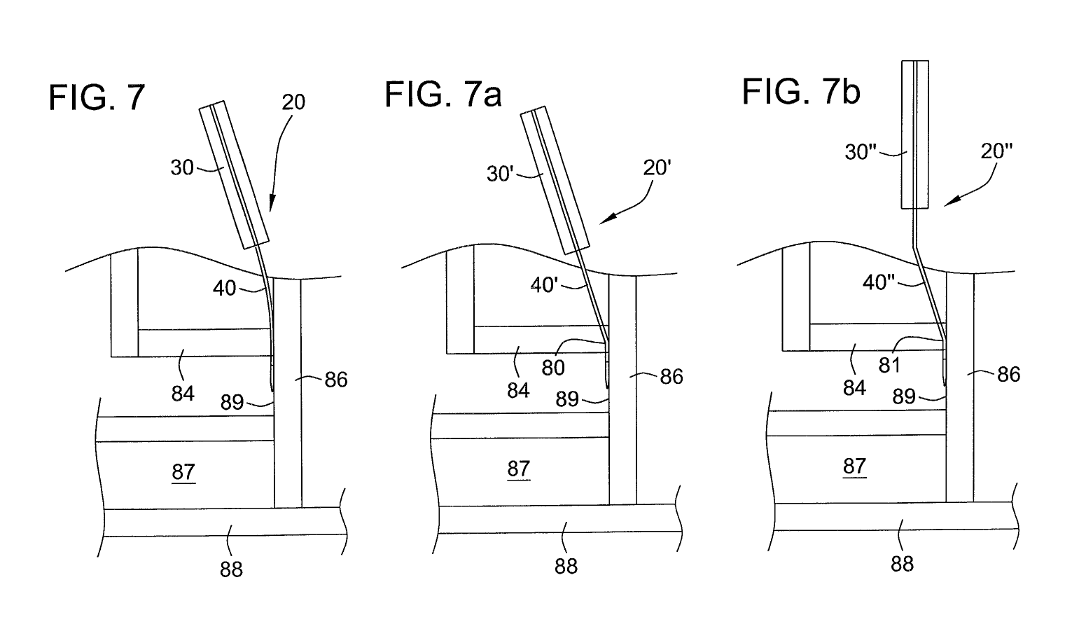

With reference to FIG. 6, a physical space where these wallpapering tools have been used has been depicted. The figure is partially cut away, but it will be recognized that the figure depicts a building fixture such as a cupboard 83 having an overhang 84. In this situation, the overhang 84 is near the floor 88 and is supported thereon by a floorboard 85. The floor board 85 includes a piece of trim 87 running along the edge of the floor 88 leaving a horizontal strip 89 of wall space to be papered. The cupboard 83 extends into a corner which is formed in conjunction with a wall 86. Like the horizontal strip 89, the wall 86 must also be wallpapered including the portion thereof directly below the overhang 84. [Note: the portion 89 will be discussed herein]. In this situation, the tool 20 can be used as depicted in FIGS. 6 and 7. More specifically, the leg 55 can be placed below the overhang 84 against the wall 86, and the straight edge 56 may be used to guide a cutting tool such as a knife along the wall 86 where it meets the overhang 84.

It will be recognized from FIG. 7 that in order to place the blade 40, and more particularly the leg portion 22 and its guiding edge 54 and straight edge 56 closely against the wall 86, it is necessary to bend the blade 40. Accordingly, the blade 40 is preferably constructed of a spring steel or other resiliently deflectable material for this purpose. It will also be recognized that the alternate embodiments of the wallpapering tool 20′, 20″ depicted in FIGS. 4 and 5 are also ideal in this situation as they would eliminate the bending of the blade 40. As shown in FIGS. 7a and 7b, the bend 80 in tool 20′, and the two bends 81, 82 in the tool 20″ allow the free end of the blade 40, and more particularly the leg 55 including the guiding edge 54 and straight edge 56, to be placed against the wall 86 so that the edges 54, 56 may be used for guiding a blade and cutting. It will also be recognized that by providing bends in the blade 40 of the wallpapering tools, the tools become either left handed or right handed. Therefore, when the wallpapering tool is provided with such bends, it is ideal to provide a leg portion 22 that projects from both lateral sides of the blade 40 so that the tool is both left handed and right handed, and would include one single guiding edge 54, and would include two straight edges 56 which would define removed sections of the blade 40. It will also be recognized that the wallpapering tool 20 as depicted in FIGS. 1, 2, 6 and 7 can be used as both a left handed and a right handed tool while utilizing only a single leg portion 22.

Turning now to FIGS. 4-8, two different situations will be illustrated where the use of the wallpapering tool 20 in these situations is also beneficial. Generally, all of these situations occur along the wall at a space between two closely spaced objects protruding from the wall, which can be further complicated by a corner formed by another vertical wall. Nonetheless, it will be recognized by those skilled in the art that innumerable other situations exist where the wallpapering tool 20 of the present invention can also facilitate the cutting of wallpaper.

Turning now to FIG. 4, a typical room such as a kitchen as illustrated having a floor 201 and vertical walls 202. Two vertical spaced cupboards 205, 206 are depicted, the lower cupboard 205 extending upwardly from the floor 201, and the upper cupboard 206 positioned vertically above the lower cupboard 205. The lower cupboard 205 also defines a countertop 208. The lower cupboard 205 includes a cupboard front wall 210 and an overhang 211. A baseboard 212 extends upwardly from the floor 201 to the overhang 211. Considering the baseboard 212 as our vertical reference, it can be seen that both the overhang 211 and the floor 201 project horizontally outward relative to the baseboard 212. This illustrates one situation in which the tool 20 of the present invention, and more specifically the leg portion 22 of the tool 20, can provide many useful benefits in cutting of wallpaper to fit the vertical surface area covered by the baseboard 212 as will be described in more detail herein. The vertical space of the wall 202 between the bottom wall 209 of the upper cupboard 206 and the countertop 208 also represents an ideal situation for employing the wallpapering tool 20 of the present invention.

Turning now to FIG. 5, which represents an enlarged view of the portion denoted by circle 5 in FIG. 4, the use of the tool 20 is illustrated. The wallpaper 300 is typically precut to the approximate size of the surface to be papered, which in the figure is represented by the outer vertical surface of baseboard 212. It will also be noted that this specific situation involves a corner as defined by a second baseboard 212′ positioned generally perpendicular to the baseboard 212. In order to cut along the line where the overhang 211 and baseboard 212 meet, the guiding edge of the wallpapering tool 20 must be placed proximate that line, while the knife 250 must be grasped by the handle 251 and the blade 252 must slide across the top surface of the guiding edge to make the cut.

It can be seen, and especially in reference to FIG. 7, that the floor 201 limits the rotation of the wallpapering tool 20 relative to the baseboard 212. Since the downward rotation of the tool 20 is limited, the amount of access space to the guiding edge is limited by the handle 30 and blade 40 of the tool, including the hand of the user grasping the handle 30. However, by way of the present invention, the leg portion 22 and the removed section provide access to the guiding edge for cutting the wallpaper 300, as shown by the removed section 301 of the wallpaper 300. It will also be noted that the overhang 211 limits the space which is available to the user for grasping the handle 251 of the knife 250 in reaching in to cut along the guiding edge of the tool 20.

As best shown in the side view of FIG. 7, the knife 250 defines a knife axis 255 while the tool 20 includes its longitudinal axis 15. The portion of the knife 250, namely the handle 251 in the person's hand using the knife, which comes very close to and overlaps the wallpapering tool 20. A person's hand is at least 2 inches wide, 4 inches long and ½ inch thick. This clearly would not be possible without the leg portion 22 and the removed section 60 of the tool 20. It can therefore be seen that the present invention allows the knife axis 255 to be disposed more closely to the longitudinal axis 15 of the wallpapering tool 20. This uniquely allows small strips of wallpaper 300 to be cut in extremely tight situations such as that depicted.

The second situation is illustrated in FIG. 6, which represents an enlarged view of the portion noted by circle 6 in FIG. 4. It will be noted that this situation involves a corner as defined by a second vertical wall 202′ positioned generally perpendicular to the wall 202 and countertop 208. In order to cut along the line where the countertop 208 and wall 202 meet, the guiding edge of the wallpapering tool 20 must be placed proximate that line, while the knife 250 must be grasped by the handle 251 and the blade 252 must slide across the top surface of the guiding edge.

It can be seen, that the countertop 208, the bottom wall 209 of the cupboard and the second vertical wall 202′ all limit access to the guiding edge, especially in the corner. The upper rotation of the tool 20 is also limited, and thus the amount of access space to the guiding edge is also limited by the handle 30 and blade 40 of the tool 20, including the hand of the user grasping the handle 30. However, by way of the present invention, the leg portion 22 and the removed section provide increased access to the guiding edge for cutting wallpaper 300.

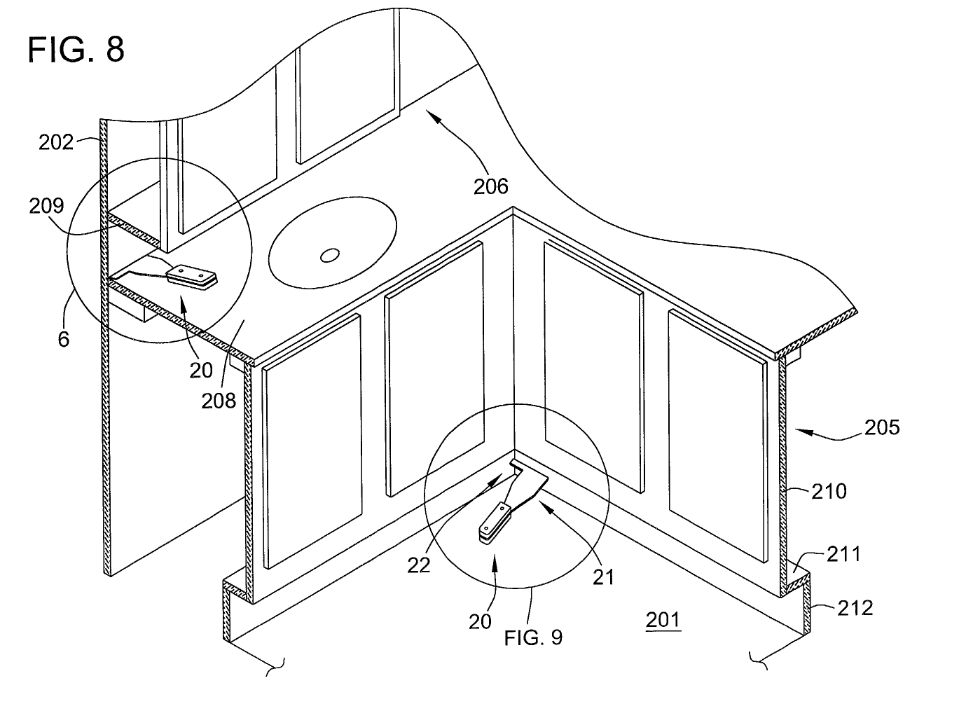

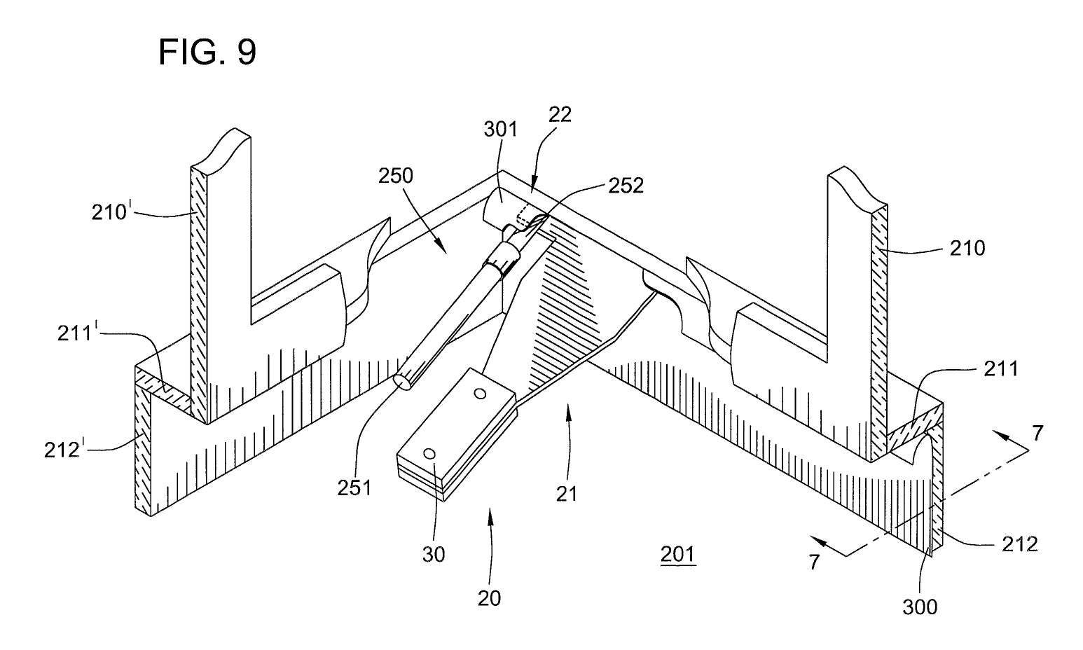

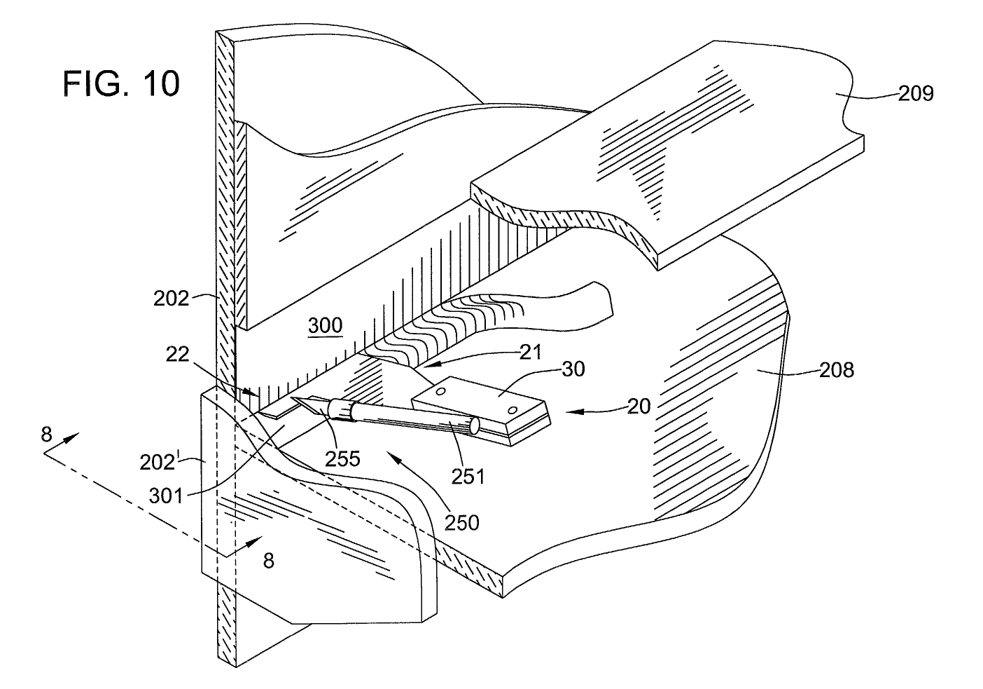

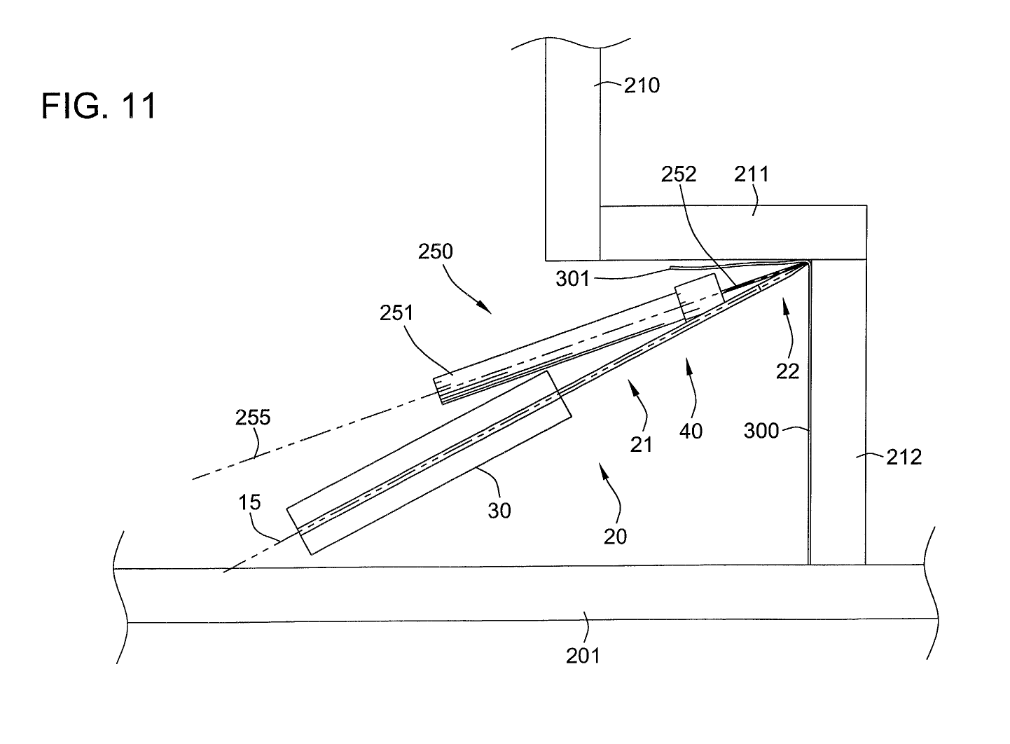

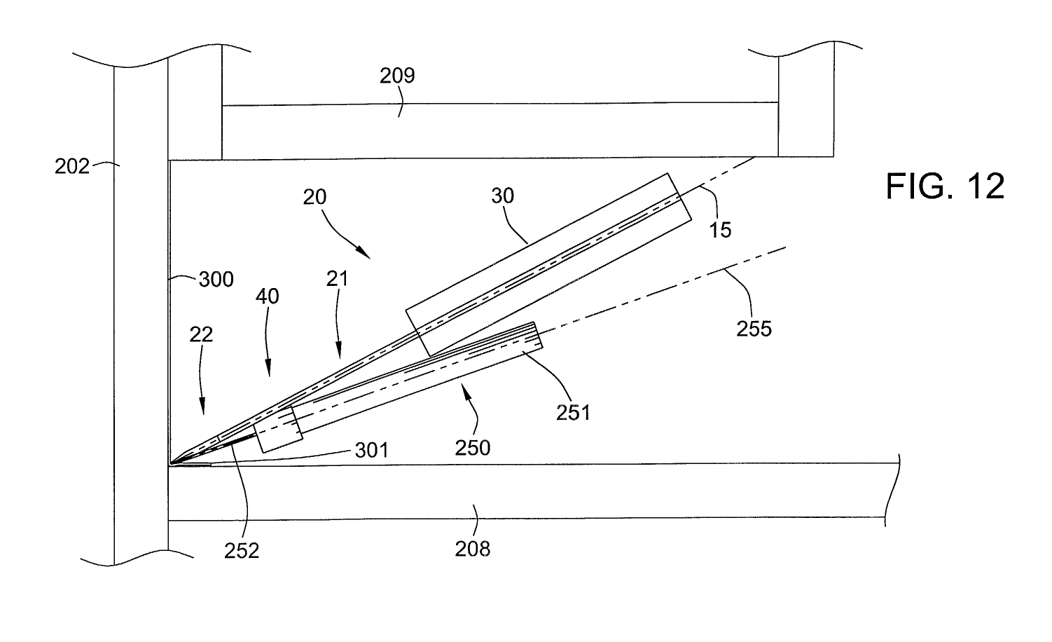

A side cross-sectional view of this situation is shown in FIG. 8, where the knife 250 and the tool 20 are in close proximity to one another. Similar to the previous situation, the knife 250 defines a knife axis 255 while the tool 20 includes its longitudinal axis 15. The portion of the knife 250, namely the handle 251 in a person's hand using the knife, come very close to and overlaps the wallpapering tool 20. The substantial similarity of the knife axis 255 and the tool axis 15 would not be possible without the leg portion 22 and the removed section 60 of the tool 20. This uniquely allows small strips of wallpaper 300 to be cut in extremely tight situations such as that depicted.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A wallpaper tool comprising:
a main portion including,
a handle defining a longitudinal axis, and
a blade connected at one end to the handle, the other free end of the blade defining a guiding edge; and
a leg portion integrally formed with the main portion and projecting laterally therefrom to further define the guiding edge, the leg portion having a substantially constant longitudinal length Lₗ across its width, Lₗ being substantially smaller than a longitudinal length Lₘ of the main portion.

2. The wallpaper tool of claim 1, wherein the leg portion is defined solely by the blade.

3. The wallpaper tool of claim 1, wherein the handle and blade define the leg portion.

4. The wallpaper tool of claim 1, wherein the length of the blade is substantially smaller than the length of the handle.

5. The wallpaper tool of claim 1, wherein Lₗ is between ⅛ inch and 1 inch.

6. The wallpaper tool of claim 1, wherein Lₗ is between ¼ inch and ½ inch.

7. The wallpaper tool of claim 1, wherein the leg portion projects laterally from the main portion a distance at least 0.75 inches.

8. The wallpaper tool of claim 1, wherein the leg portion projects laterally from the main portion a distance at least 1 inch.

9. The wallpaper tool of claim 1, wherein the guiding edge is generally perpendicular to the longitudinal axis

10. A tool for guiding a knife cutting wallpaper comprising:
a handle;
a blade connected to the handle and projecting therefrom to a free end having a guiding edge, the blade and handle defining a common longitudinal axis;
a removed section providing access to the guiding edge, the removed section beginning at a free end of the handle and extending to a straight edge formed in one of the blade and handle, the straight edge disposed generally parallel to the guiding edge and spaced therefrom a short distance relative to the overall length of the wallpapering tool.

11. The tool of claim 10, wherein the removed section is further defined by an edge on a lateral side of one of the blade and handle, the edge angled relative to the longitudinal axis.

12. The tool of claim 10, the knife having a handle and blade defining a knife axis, the knife handle adapted to be gripped by the hand of a person, wherein:
the removed section is sized to accommodate a substantial portion of the hand of a person gripping the knife handle.

13. The tool of claim 10, the knife having a handle and blade defining a knife axis, wherein:
the removed section is sized to permit the knife axis to be disposed on an angle substantially similar to the angle of the tool's longitudinal axis.

14. The tool of claim 13, wherein angles of the knife axis and tool's longitudinal axis differ by less than 30°.

15. The tool of claim 10, wherein the distance between the straight and guiding edges is between ⅛ inch and 1 inch.

16. The tool of claim 10, wherein the removed section is formed solely in the handle.

17. The tool of claim 10, wherein the removed section is formed solely in the blade.

18. The tool of claim 10, wherein the blade has a first section angled relative to a second section.

19. The tool of claim 18, wherein the boundary between the first and second sections is co-linear with the straight edge.

20. The tool of claim 18, wherein the blade has a third section angled relative to the second section.

21. The tool of claim 20, wherein first and third blade sections are parallel to one another.

22. A wallpaper tool comprising:
a handle;
a blade having one end connected to the handle and extending longitudinally to a free end;
a leg integrally joined to the blade adjacent the blade's free end and projecting laterally therefrom at least 0.75 inches;
the free end of the blade and the free end of the leg defining a guiding edge.

23. The wallpaper tool of claim 22, wherein a straight edge of the leg opposite the guiding edge is generally parallel to the guiding edge.

24. The wallpaper tool of claim 22, wherein the lateral width of the guiding edge is at least 1.75 inches.
